(19) United States
(12) Patent Application Publication
(10) Pub. No.: US 2023/0229933 A1
(43) Pub. Date: Jul. 20, 2023

(54) SYSTEMS AND METHODS FOR IMPLEMENTING QUANTUM BRANCH-AND-BOUND ALGORITHMS WITH HEURISTICS

(71) Applicant: JPMORGAN CHASE BANK , N.A., New York, NY (US)

(72) Inventors: Shouvanik CHAKRABARTI, New York, NY (US); Pierre MINSSEN, New York, NY (US); Romina YALOVETZKY, Buenos Aires (AR); Marco PISTOIA, Amawalk, NY (US)

(21) Appl. No.: 17/648,054

(22) Filed: Jan. 14, 2022

(51) Int. Cl. G06N 5/00; G06N 10/60

(52) U.S. Cl. CPC G06N 5/003; G06N 10/60

(57) ABSTRACT

Quantum branch-and-bound algorithms with heuristics are disclosed. A method may include: receiving a branch and bound problem; setting an upper bound, a best bound, an incumbent, and a counter i; executing a subtree estimation procedure that returns branch_m that represents a tree of size m; determining branch_i and cost_i for branch_m; setting cost_feas to a value COST(N) for feasible nodes N, and to +∞ for unfeasible nodes; instructing a quantum computer to execute a QuantumMinimumLeaf procedure to get a node N and setting incumbent′ to COST(N); instructing the quantum computer to execute the QuantumMinimumLeaf procedure to get a node N′ and to setting best bound′ to equal COST(N′); and returning the node N when an absolute value of a difference between a minimum of incumbent and incumbent′ and a minimum of best bound and best bound′ is less than the approximation margin.

### BACKGROUND OF THE INVENTION

### 1. Field of the Invention

Embodiments relate generally to systems and methods for implementing quantum branch-and-bound algorithms with heuristics.

### 2. Description of the Related Art

Mixed Integer Programming (MIP) is used as a mathematical model to solve problems in many areas of computing including combinatorial optimization (e.g., travelling salesman problem (TSP)), physical simulation (e.g., ground states of Ising models), and finance (e.g., portfolio optimization). In general, the best algorithms for MIP take time that is exponential in the number of optimization variables. MIP also belongs to the class of NP-Hard problems; therefore, a polynomial dependence is likely not possible without violating widely believed conjectures in complexity theory. In practice however, MIP problems of a moderate size can be solved using numerical algorithms. Due to the wide applicability of MIP, any improvements in performance of algorithms that leads to increases in the size of problems that can be feasibly solved can bring large economic benefits to several industries.

Branch-and-Bound algorithms are among the most widely used paradigms for solving MIP. A branch-and-bound algorithm recursively explores a tree of progressively refined relaxed versions of the problem, and the worst-case runtime is the size of the tree explored. Classical branch-and-bound algorithms are often able to perform significantly better than their worst-case runtime on practical problems, by leveraging search heuristics that influence the order in which the nodes of the tree are explored. Cleverly chosen heuristics can result in a sufficiently good approximate solution being found without having to explore the whole tree.

Existing quantum algorithms may improve the worst-case runtime almost quadratically in the size of the tree. A limitation of existing quantum approaches is that they do not incorporate search heuristics, and only search for exactly optimal solutions. Therefore, they cannot be adapted to use domain knowledge on the problems at hand, and can be outperformed by classical algorithms despite the superior worst-case guarantee.

### SUMMARY OF THE INVENTION

Systems and methods for implementing quantum branch-and-bound algorithms with heuristics are disclosed. According to one embodiment, a quantum computer-based branch-and-bound method with a heuristic function may include: (1) receiving, by a classical computer program executed by a computer processor, a branch and bound problem comprising a root, a depth, a maximum cost, a failure probability, an approximation margin, and a heuristic function that is depth based or cost based; (2) setting, by the classical computer program, an upper bound, a value best bound, a value incumbent, and a counter i; (3) executing, by the classical computer program, a subtree estimation procedure with the root, a value 2ⁱ, a BRANCH function, a COST function, the depth, the failure probability, the approximation margin, and the heuristic function, wherein the subtree estimation procedure returns branch_m that represents a tree of size m with minimal value for the heuristic function; (4) determining, by the classical computer program, a value branch_i and a value cost_i based on branch_m; (5) setting, by the classical computer program, a variable cost_feas to a value COST(N) for feasible nodes N, and to +∞ for unfeasible nodes; (6) instructing, by the classical computer program, a quantum computer to execute a QuantumMinimumLeaf procedure with the value branch_i, the value COST(N), the depth, the maximum cost, the failure probability, and the approximation margin to get a node N and setting a value incumbent′ to equal to the value COST(N); (7) instructing, by the classical computer program, the quantum computer to execute the QuantumMinimumLeaf procedure with branch_i, cost_i, the depth, the maximum cost, the failure probability, and the approximation margin to get a node N′ and to set a value best bound′ to equal COST(N′); and (8) returning, by the classical computer program, the node N when an absolute value of a difference between a minimum of the value incumbent and the value incumbent′ and a minimum of the value best bound and the value best bound′ is less than the approximation margin.

In one embodiment, the method may further include estimating, by the classical computer program, the depth and the maximum cost.

In one embodiment, the depth is estimated as a number of assets in a portfolio, and the maximum cost is estimated as the number of assets in the portfolio multiplied by a highest price of one of the assets in the portfolio.

In one embodiment, the step of executing, by the classical computer program, the subtree estimation procedure comprises: executing, by the classical computer program, a cost subtree estimation procedure in response to the heuristic function being cost based; and executing, by the classical computer program, a depth subtree estimation procedure in response to the heuristic function being depth based.

In one embodiment, the depth subtree estimation procedure returns the value for each Node N and keeps a child node present in the branch_m.

In one embodiment, the step of executing the depth subtree estimation procedure in response to the heuristic function being depth based comprises: instructing, by the classical computer program, the quantum computer to execute a quantum tree size procedure to get a size estimation.

In one embodiment, the cost subtree estimation procedure returns the branch_m comprising values in a tree V_1 as branch_1 and values in a tree V_2 as branch_2.

In one embodiment, the cost subtree estimation procedure iteratively estimates a size of a tree to reach a wanted cost until there are fewer that 2ⁱ⁺¹ nodes.

In one embodiment, the step of executing the cost subtree estimation procedure in response to the heuristic function being cost based comprises: instructing, by the classical computer program, the quantum computer to execute a quantum tree size procedure to get a size estimation.

In one embodiment, the method may further include increasing the value of the counter i by 1, and repeating the steps of the classical computer program executing the subtree estimation procedure, determining the value branch_i and the value cost_i based on branch_m, assigning the value COST(N) to feasible nodes and a value +∞ to unfeasible nodes, instructing the quantum computer to execute the QuantumMinimumLeaf procedure with the value branch_i, the value COST(N), the depth, the maximum cost, the failure probability, and the approximation margin to get a node N and setting a value incumbent′ to equal to the value COST(N), instructing the quantum computer to execute the QuantumMinimumLeaf procedure with branch_i, cost_i, the depth, the maximum cost, the failure probability, and the approximation margin to get a node N′ and to set a value best bound′ to equal COST(N′), receiving the node N, and returning the node N when an absolute value of a difference between the minimum of the value incumbent and the value incumbent′ and the minimum of the value best bound and the value best bound′ is less than the approximation margin.

According to another embodiment, a system may include: a classical computer comprising a memory storing a classical computer program and a computer processor; and quantum computer; wherein: the classical computer program receives a branch and bound problem comprising a root, a depth, a maximum cost, a failure probability, an approximation margin, and a heuristic function that is depth based or cost based; the classical computer program sets an upper bound, a value best bound, a value incumbent, and a counter i; the classical computer program executes a subtree estimation procedure with the root, a value 2ⁱ, a BRANCH function, a COST function, the depth, the failure probability, the approximation margin, and the heuristic function, wherein the subtree estimation procedure returns value branch_m that represents a tree of size m with minimal value for the heuristic function; the classical computer program determines a value branch_i and a value cost_i based on branch_m; the classical computer program sets a variable cost_feas to a value COST(N) for feasible nodes N, and to +∞ for unfeasible nodes; the classical computer program instructs the quantum computer to execute a QuantumMinimumLeaf procedure with the value branch_i, the value COST(N), the depth, the maximum cost, the failure probability, and the approximation margin; the quantum computer executes the QuantumMinimumLeaf procedure and returns a node N; the classical computer program sets a value incumbent′ to equal to the value COST(N); the classical computer program instructs the quantum computer to execute the QuantumMinimumLeaf procedure with branch_i, cost_i, the depth, the maximum cost, the failure probability, and the approximation margin; the quantum computer executes the QuantumMinimumLeaf procedure and returns a node N′; the classical computer program sets a value best bound′ to equal COST(N′); and returning, by the classical computer program, the node N when an absolute value of a difference between a minimum of the value incumbent and the value incumbent′ and a minimum of the value best bound and the value best bound′ is less than the approximation margin.

In one embodiment, the classical computer program further estimates the depth and the maximum cost.

In one embodiment, the depth is estimated as a number of assets in a portfolio, and the maximum cost is estimated as the number of assets in the portfolio multiplied by a highest price of one of the assets in the portfolio.

In one embodiment, the classical computer program executes the subtree estimation procedure by: executing, by the classical computer program, a cost subtree estimation procedure in response to the heuristic function being cost based; and executing, by the classical computer program, a depth subtree estimation procedure in response to the heuristic function being depth based.

In one embodiment, the depth subtree estimation procedure returns the value for each Node N and keeps a child node present in the branch_m.

In one embodiment, the depth cost subtree estimation procedure comprises instructing, by the classical computer program, the quantum computer to execute a quantum tree size procedure to get a size estimation.

In one embodiment, the cost subtree estimation procedure returns the branch_m comprising values in a tree V_1 as branch_1 and values in a tree V_2 as branch_2.

In one embodiment, the cost subtree estimation procedure iteratively estimates a size of a tree to reach a wanted cost until there are fewer that 2ⁱ⁺¹ nodes.

In one embodiment, the cost subtree estimation procedure comprises: instructing, by the classical computer program, the quantum computer to execute a quantum tree size procedure to get a size estimation.

In one embodiment, the classical computer program increases the value of the counter i by 1, and repeats executing the subtree estimation procedure, determining the value branch_i and the value cost_i based on branch_m, assigning the value COST(N) to feasible nodes and a value +∞ to unfeasible nodes, instructing the quantum computer to execute the QuantumMinimumLeaf procedure with the value branch_i, the value COST(N), the depth, the maximum cost, the failure probability, and the approximation margin to get a node N and setting a value incumbent′ to equal to the value COST(N), instructing the quantum computer to execute the QuantumMinimumLeaf procedure with branch_i, cost_i, the depth, the maximum cost, the failure probability, and the approximation margin to get a node N′ and to set a value best bound′ to equal COST(N′), receiving the node N, and returning the node N when an absolute value of the difference between the minimum of the value incumbent and the value incumbent′ and the minimum of the value best bound and the value best bound′ is less than the approximation margin.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for implementing quantum branch-and-bound algorithms with heuristics according to one embodiment;

FIG. 2 depicts a method for implementing quantum branch-and-bound algorithms with heuristics according to one embodiment;

FIG. 3 depicts an illustrative subtree estimation procedure according to one embodiment;

FIG. 4 depicts an exemplary depth subtree estimation procedure according to one embodiment;

FIGS. 5A and 5B depict an exemplary cost subtree estimation procedure according to one embodiment; and

FIG. 6 depicts an exemplary truncate function according to one embodiment.

### DETAILED DESCRIPTION OF PREFERRED EMBODIMENTS

Embodiments are directed to systems and methods for implementing quantum branch-and-bound algorithms with heuristics. For example, the disclosed quantum branch-and-bound algorithms offer more practical speedups over classical methods while still having worst-case guarantees no worse than existing quantum approaches. For broad classes of search heuristics, embodiments are almost quadratically faster than the actual performance of the classical algorithm on a particular problem rather than its worst-case guarantee. Thus, embodiments provide a faster computation for the final result.

Classical branch-and-bound algorithms recursively search a tree of relaxations of a given MIP (where a relaxation is obtained by removing the integrality). Due to the convexity of the objective as well as the constraint set, the relaxation is efficiently solvable (with polynomial runtime n) by several well-known classical methods. The solution to the relaxed problem does not in general satisfy the integrality constraints and therefore is not feasible. The tree to be searched may defined as follows:

1. Each node is an optimization problem with objective f and a convex constraint set. The cost of a node is the value of the objective function at the solution of the optimization problem. This defines the cost oracle corresponding to the problem.

2. The root corresponds to the original MIP with the integrality constraint removed.

3. At any node N, let the optimization problem have solution n. Let j be the coordinate of n with the smallest fractional part among coordinates in S. The two children of N are defined to be N1, N2 which contain the same problem as N with added constraints xⱼ≤[nⱼ] and xⱼ≥[nⱼ]. This defines a branch oracle corresponding to the problem.

4. Every node N where every co-ordinate of xₛ is integral is a leaf of the tree, and represents a feasible solution to the original MIP.

Solving an MIP via branch-and-bound reduces to finding the leaf of the above defined tree that has minimum cost. This may be accomplished by performing a tree-search over the nodes of the graph. During this search, a node is discovered when it is first obtained by solving the optimization problem at its parent. Once the problem at a node is solved and both its children discovered, it may be explored. Any discovered node that has not yet been explored is active. A search heuristic specifies the order in which active nodes are to be explored. During the progress of the algorithm, two quantities are maintained:

1. An incumbent representing the solution of minimum cost feasible node that has been discovered so far. As the algorithm progresses, the algorithm is the value of the minimum feasible solution found so far (this is the current best candidate). When the value of the incumbent is within the approximation margin of the best bound, an acceptable solution has been identified.

The cost of the incumbent solution is an upper bound on the cost of the solution. The upper bound is an upper bound on the maximum possible value of the optimal solution.

2. A best bound representing the solution of the minimum cost active node. The cost of best bound is a lower bound on the cost of the solution. As the algorithm progresses, the best bound is an upper bound indicating a current estimate of the maximum possible value of the optimal solution (as more and more nodes are explored the early rough estimate provided by the upper bound is be refined).

The difference between the cost of the Incumbent and best bound is termed the gap. When the gap is below ϵ, the Incumbent represents an ϵ-approximate solution to the MIP.

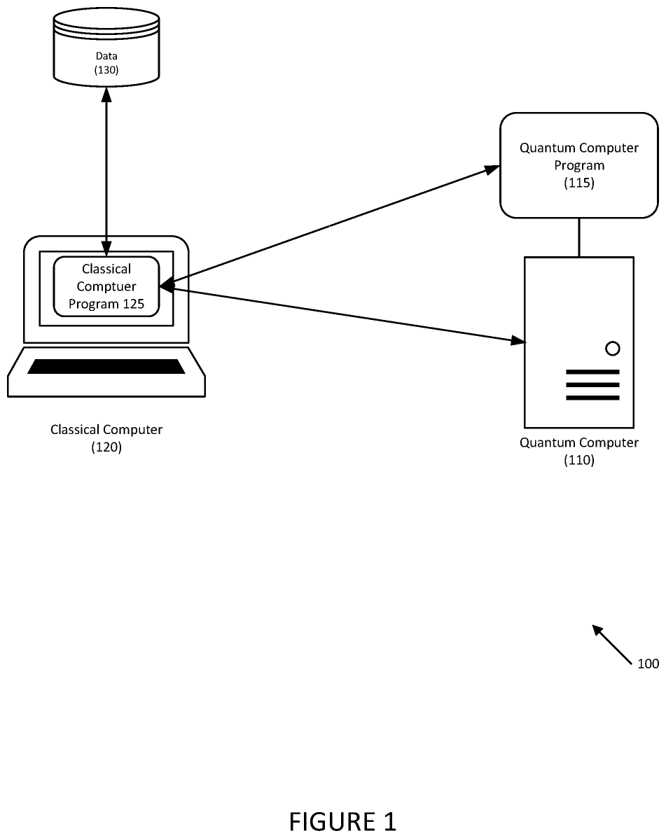

Referring to FIG. 1, a system for implementing quantum branch-and-bound algorithms with heuristics is disclosed according to an embodiment. System 100 may include quantum computer 110 that may execute quantum computer program 115. Classical computer 120 may interface with quantum computer program 115 using classical computer program 125. Classical computer 120 may be any suitable classical computing device, including servers, workstations, desktop, notebook, laptop, or tablet computers, etc.

Quantum computer 110 may be a Noisy Intermediate-Scale Quantum (NISQ) computer.

Classical computer program 125 may provide input to, and receive output from, quantum computer 110 and/or quantum computer program 115. In one embodiment, classical computer program 125 may generate one or more quantum computer programs 115, such as one or more quantum circuits, and may provide one or more quantum computer programs 115 to quantum computer 110. Classical computer program 125 may receive the results of the execution of the one or more quantum computer programs 115.

Database 130 may be a source of data. For example, the input data may be historical market data, production data, scheduling data, etc. Any suitable input data for which optimization may be desired may be used as is necessary and/or desired

In one embodiment, classical computer program 125 may create one or more quantum circuits that implements at least portions of a quantum branch-and-bound algorithm with heuristics. Classical computer program 125 may then transpile the quantum circuit(s) and may then send the transpiled circuit(s) to the quantum computer for execution. Classical computer program 125 may receive the results from the quantum computer.

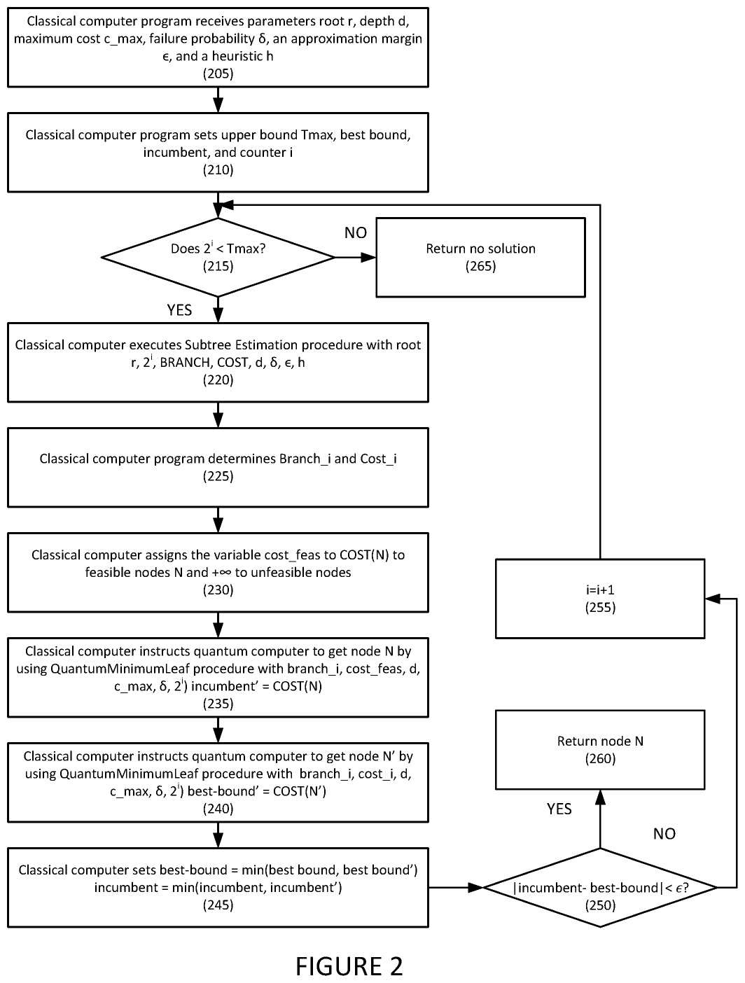

Referring to FIG. 2, a method for implementing quantum branch-and-bound algorithms with heuristics is disclosed according to an embodiment. In step 205, a classical computer program may receive parameters for a branch and bound problem, including, for example, a value root r, a depth d, a maximum cost c_max, a failure probability δ, and an approximation margin ϵ for the quantum branch-and-bound algorithm. In one embodiment, the root r, the depth d, the maximum cost c_max may be features of the branch and bound problem; the depth d and the maximum cost c_max may be estimated.

In one embodiment, the approximation margin ϵ may represent the acceptable suboptimality of the returned solution. The returned solution need not be the minimum returned, but needs to have a value within ϵ of the optimal solution.

Any suitable manner of estimating the depth d and the maximum cost c_max may be used as is necessary and/or desired. For example, in a financial branch and bound problem, the depth may be estimated to be the number of assets in a portfolio, and the maximum cost may be set to be the number of assets times the highest price of an asset. Any other suitable manner of estimating the depth and maximum cost may be used as is necessary and/or desired.

The failure probability δ and the approximation margin ϵ may selected based on the specifics of the application, such as the desired precision, accuracy, etc.

In one embodiment, the quantum computer program may receive a heuristic h, such as the order in which the nodes are evaluated, as part of the branch and bound problem. In one embodiment, heuristic h may be a function.

In one embodiment, the heuristic h may be depth based, or it may be cost based. For example, the heuristic may decide whether to explore the tree in a depth-first search manner, or in a cost-first search manner. In the depth-first search manner, each node's children are ordered, and the algorithm keeps exploring the left child until a leaf is reached and then backtracks. In the cost-first search manner, the heuristic associates a cost with each discovered node. The algorithm then explores the discovered node with minimum cost.

In step 210, the classical computer program may initialize an upper bound Tmax, a best bound, an incumbent bound, and a counter i for the branch and bound problem. In one embodiment, the upper bound Tmax may be set to 2^{d}, the best bound may be set to +∞, the incumbent bound may be set to −∞, and counter i may be set to 1.

In step 215, the classical computer program may determine if 2ⁱ is less than Tmax. If it is not, in step 265, the classical computer program may return no solution.

If 2ⁱ is less than Tmax, in step 220, the classical computer program may execute a Subtree Estimation procedure using the root r, a value 2ⁱ, a BRANCH function (received as part of the problem), a COST function (received as part of the problem), the depth d, the failure probability δ, the approximation margin ϵ, and the heuristic h.

In one embodiment, the BRANCH function may be called on a node and may output a description of all its children nodes. The COST function may be called on a node and may return the cost of the node. The goal of branch and bound is to find the leaf node with minimum cost.

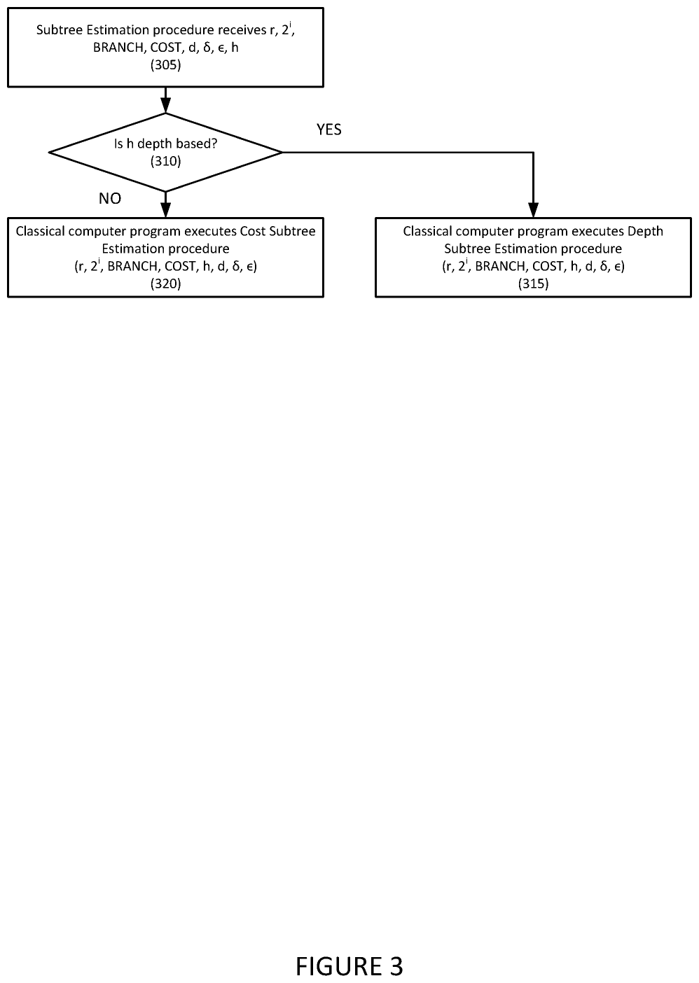

An example of the Subtree Estimation procedure is provided in FIG. 3.

Referring to FIG. 3, in step 305, the classical computer program may receive the root r, the value 2ⁱ, the branch, the cost, the depth d, the failure probability δ, the approximation margin ϵ, and the heuristic h.

In step 310, if the heuristic h is depth based, in step 315, the classical computer program may execute a Depth Subtree Estimation procedure with the root r, the value 2ⁱ, the BRANCH function, the COST function, the depth d, the failure probability δ, the approximation margin ϵ, and the heuristic unction h.

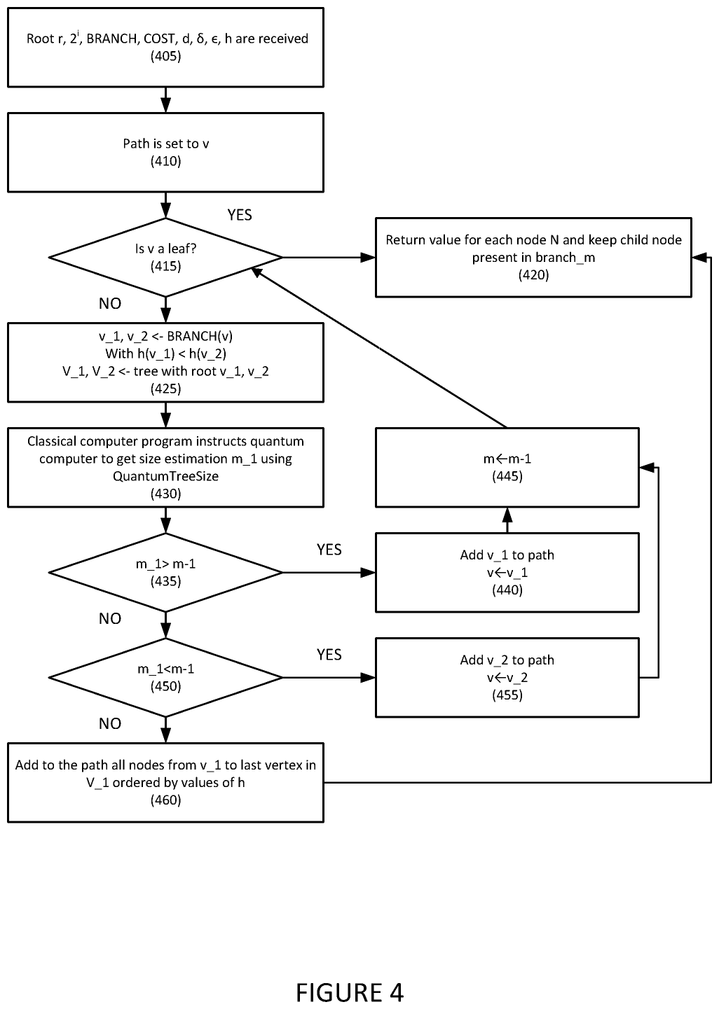

Referring to FIG. 4, a depth subtree estimation procedure is illustrated according to an embodiment.

In step 405, the root r, the value 2ⁱ, the BRANCH function, the COST function, the depth d, the failure probability δ, the approximation margin ϵ, and the heuristic function h may be received.

In step 410, the classical computer program may set the path to v.

In step 415, if v is a leaf, in step 420, the classical computer program may return the value N for each node and may keep only one child node present in the path branch_m. It may drop the other child nodes.

If v is not a leaf, in step 425, the classical computer program procedure may set v_1 and v_2 with BRANCH(v) when h(v_1)<h(v_2). v_1 and v_2 represent a tree with roots v_1, v_2.

In step 430, the classical computer program may instruct the quantum computer to get m_1, a size estimation, using QuantumTreeSize(v_1, BRANCH, COST, 1−δ/d, 2^{j}/(1−ϵ)).

An example of a QuantumTreeSize quantum procedure is described in Ambainis et al, “Quantum algorithm for tree size estimation, with applications to backtracking and 2-player games,” available at arXiv:1704.06774, the disclosure of which is hereby incorporated, by reference, in its entirety.

In step 435, if m_1>m−1, then in step 440, the classical computer program may add v_1 to path and set v equal to v_1. In step 445, the classical computer program may set m to m−1 and the process continues with step 415 in which the classical computer program may check to see if v, which is equal to v_1, is a leaf.

In step 450, if m_1<m−1, in step 455, the classical computer program may add v_2 to the path, and may set v to be v_2. The process continues with step 445.

In step 460, based on the results of steps 435 and 450, m_1 is equal to m−1, and the classical computer program may add all nodes from v_1 to last vertex in V_1 in the path ordered by values of h.

In step 420, the classical computer program may return branch_m. Branch_m may represent the tree of size m with a minimal value for the heuristic function h.

Referring again to step 310 of FIG. 3, if the heuristic h is not depth based (i.e., it is cost based), in step 320 the classical computer program procedure may determine that h is cost based, and may execute a Cost Subtree Estimation procedure with the root r, the value 2ⁱ, the BRANCH function, the COST function, the depth d, the failure probability δ, the approximation margin ϵ, and the heuristic function h.

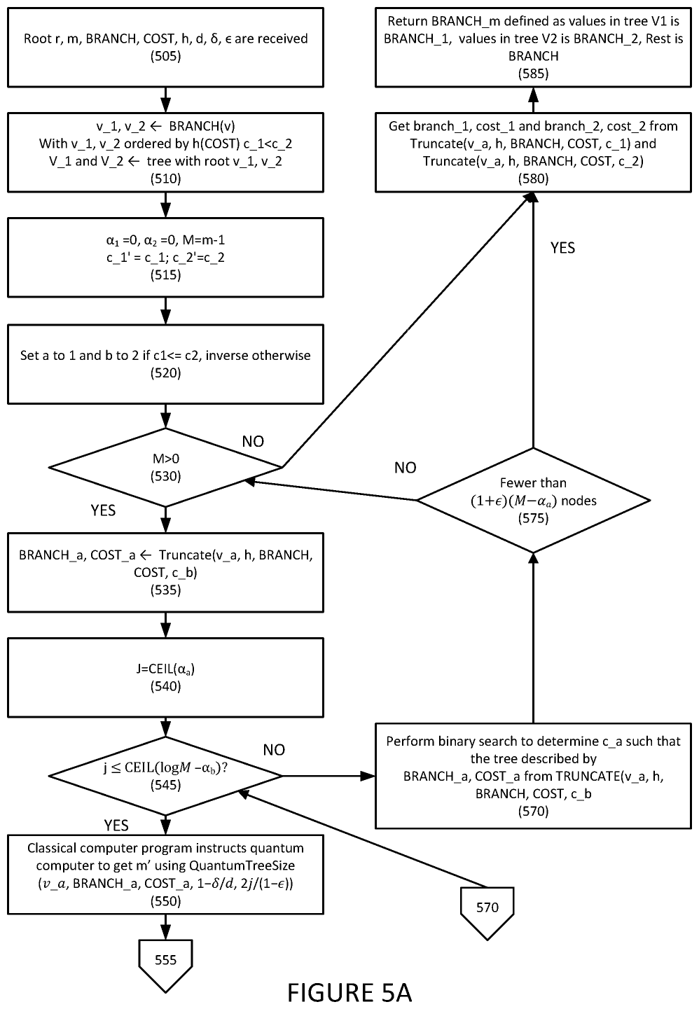

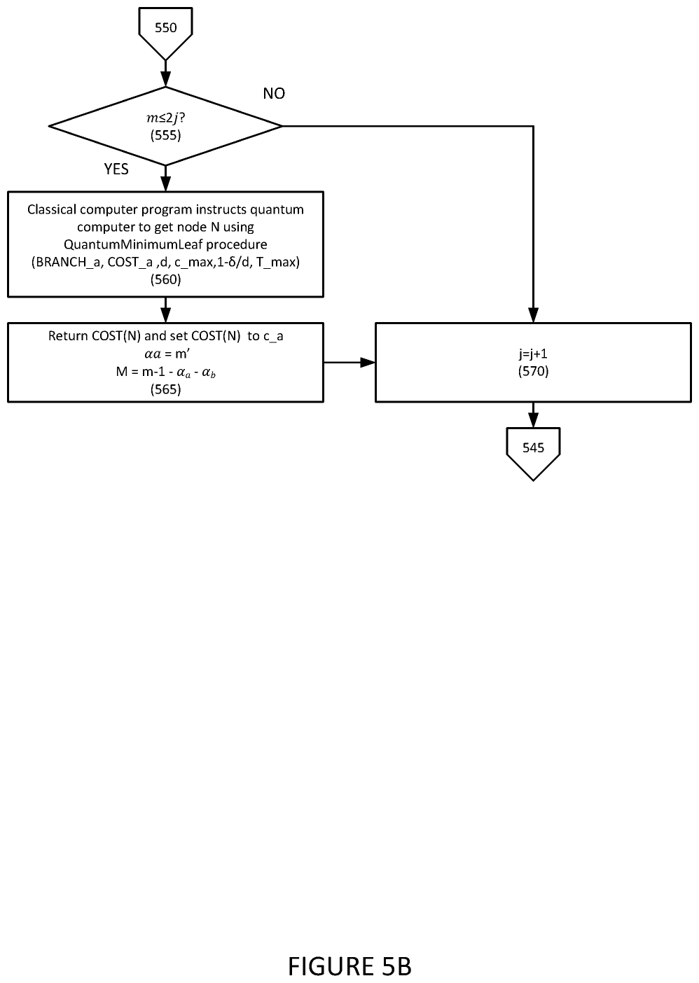

Referring to FIGS. 5A and 5B, an exemplary cost subtree estimation procedure is provided according to an embodiment.

In step 505, the root r, the BRANCH function, the COST function, the depth d, the failure probability δ, the approximation margin ϵ, and the heuristic function h may be, where v is the input node from the branch and bound procedure.

In step 510, the classical computer program may set v_1, v_2 to be branch (v), with v_1 and v_2 such that c_1<c_2, with c_1=h(COST(v_1)) and c_2=h(COST(v_2)).

In step 515, the classical computer program may set α₁ and α₂ to 0, may set M to m−1, may set c_1′ equal to c_1, and c_2′ equal to c_2.

In step 520, the classical computer program may set a to 1 and b to 2 if c_1 is less than or equal to c_2. If not, a may be set to 2 and b may be set to 1.

In step 530, if M is not greater than 0, in step 580, the classical computer program may get branch_1, cost_1 and branch_2, cost_2 from TRUNCATE(v_a, h, BRANCH, COST, c_1) and TRUNCATE(v_a, h, BRANCH, COST, c_2).

In step 585, the classical computer program may return branch_m defined as values in tree V_1 as branch_1, values in tree V_2 may be returned as branch_2, and the rest may be returned as the BRANCH function.

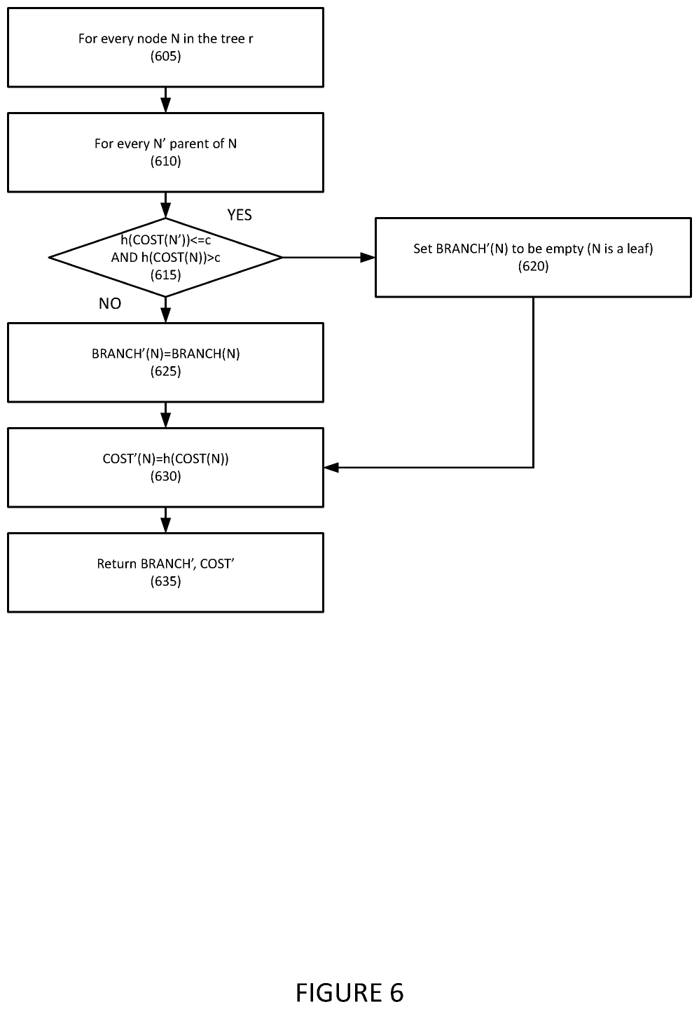

If M is greater than 0, in step 535, the classical computer program may set branch_a, cost_a by calling the function TRUNCATE(v_a, h, BRANCH, COST, c_b). Referring to FIG. 6, an example TRUNCATE function is provided according to an embodiment.

In step 605, for every node N in the tree r, and in step 610, for every N′ parent node of N, in step 615, if h(COST(N′)) is less than or equal to c and h(COST (N)) is greater than c, then in step 625, the TRUNCATE function may set branch′ (N) to equal branch(N).

In step 630, the TRUNCATE function may set COST′(N), to equal h(COST (N)), and in step 635, the values branch′, cost′ are returned.

If h(COST (N′)) is not less than or equal to c or h(COST (N)) is not greater than c, in step 620, the TRUNCATE function may set branch′ (N) to be empty. This means that N is a leaf. The process continues to step 630.

Referring again to FIGS. 5A and 5B, in step 540, the classical computer program may set j to CEIL(αₐ), wherein CEIL is a function that rounds float numbers to the next greater integer.

In step 545, if j is not less than or greater than CEIL(log M−α_{b}) in step 570, the classical computer program may perform a binary search to determine c_a such that the tree described by branch_a, cost_a from TRUNCATE(v_a, h, BRANCH, COST, c_b).

In step 575, if there are fewer than (1+ϵ)(M−αₐ) nodes, in step 580, the classical computer program may execute TRUNCATE(v_a, h, BRANCH, COST, c_1) and TRUNCATE(v_a, h, BRANCH, COST, c_2) are executed and the branch_1, cost_1 and branch_2, cost_2 are returned. The truncate procedures are described above in steps 605-635.

If j is less than or equal to CEIL(log M−α_{b}), in step 550, the classical computer program may instruct the quantum computer to get m′, a size estimation using QuantumTreeSize(v_a, branch_a, cost_a, 1−δ/d, 2^{j}/(1−ϵ)).

In step 555, if m is less than or equal to 2j, in step 560, the classical computer program may instruct the quantum computer to get node N using QuantumMinimumLeaf(branch_a, cost_a, depth_d, c_max, 1−δ/d, T_max).

In step 565, the classical computer program may return COST(N) and may then set COST(N) equal to c_a. The TRUNCATE function outputs two values, branch_a and cost_a, that represent a tree. The tree produced depends in part on the value of the variable c_a′. To find a tree that has at least 2^{j} nodes to equal m−1−αₐ−α_{b}, the classical computer program may perform a binary search on the variable c_a′. For example, the classical computer program may iteratively test multiple values following a binary search logic until it finds a tree within the requirements. For each tested value of c_a′, the classical computer program may set new values for the variables branch_a and cost_a, and may stop the binary search whet the specifications of the produced tree are met. At the end of this binary search, the classical computer program may set a value to c_a′ such that the output of TRUNCATE(v_a, h, BRANCH, c_a′), stored in the variables branch_a and cost_a, represent a tree within the requirements.

In step 570, the classical computer program may increase j by 1 and the process may return to step 545.

If m is not less than or equal to 2^{j}, the process may continue to step 570.

Referring again to FIG. 2, in step 225, the classical computer program may determine branch_i and cost_i based on branch_m, the return from the QuantumSubtreeEstimation procedure.

In step 230, the classical computer program may set cost_feas to COST(N) for feasible nodes N, and +∞ for unfeasible nodes.

In step 235, the classical computer program may instruct the quantum computer to execute the QuantumMinimumLeaf procedure with branch_i, cost_feas, the depth d, c_max, the failure probability δ, the value 2ⁱ and the value incumbent′ set equal to COST(N) to determine node N. An example of a suitable QuantumMinimumLeaf quantum procedure is described in Montanaro, “Quantum speedup of branch-and-bound algorithms,” Phys. Rev. Research 2, 013056 (2020), the disclosure of which is hereby incorporated, by reference, in its entirety. The QuantumMiminumLeaf may return the node N with minimal cost of a feasible solution given the cost function cost_feas. Thus, COST(N) is an upper bound on the solution, which may be called incumbent′ and may be compared to prior Incumbent in step 245, below.

In step 240, the classical computer program may instruct a quantum computer to execute the QuantumMinimumLeaf procedure with branch_i, cost_i, depth d, c_max, the failure probability δ, the value 2ⁱ, and a value best bound′ that is set equal to COST(N′) to determine node N′. The QuantumMinimumLeaf quantum procedure return the node N′ with lowest cost following cost_i minus the solution of minimum cost in the active node. N′ is not necessarily feasible and may not be a valid solution; however, it provides a lower-bound (called best bound′) to the solution. This best bound′ may be compared to best bound in step 245, below, to update the best bound value.

In step 245, the classical computer program may set value best bound to equal MIN(best bound, best bound′) and Incumbent to equal MIN(Incumbent, Incumbent′).

In step 250, if the absolute value of the incumbent minus the best bound is less than approximation margin ϵ, then in step 260, the classical computer program may return node N. If not, in step 255, the classical computer may increase counter i by 1, and may repeat step 215.

Although several embodiments have been disclosed, it should be recognized that these embodiments are not exclusive to each other, and certain elements or features from one embodiment may be used with another.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

In one embodiment, the processing machine may be a classical computer, a quantum computer, etc.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, a memory stick, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A quantum computer-based branch-and-bound method with a heuristic function, comprising:
receiving, by a classical computer program executed by a computer processor, a branch and bound problem comprising a root, a depth, a maximum cost, a failure probability, an approximation margin, and a heuristic function that is depth based or cost based;
setting, by the classical computer program, an upper bound, a value best bound, a value incumbent, and a counter i;
executing, by the classical computer program, a subtree estimation procedure with the root, a value 2ⁱ, a BRANCH function, a COST function, the depth, the failure probability, the approximation margin, and the heuristic function, wherein the subtree estimation procedure returns branch_m that represents a tree of size m with minimal value for the heuristic function;
determining, by the classical computer program, a value branch_i and a value cost_i based on branch_m;
setting, by the classical computer program, a variable cost_feas to a value COST(N) for feasible nodes N, and to +∞ for unfeasible nodes;
instructing, by the classical computer program, a quantum computer to execute a QuantumMinimumLeaf procedure with the value branch_i, the value COST(N), the depth, the maximum cost, the failure probability, and the approximation margin to get a node N and setting a value incumbent′ to equal to the value COST(N);
instructing, by the classical computer program, the quantum computer to execute the QuantumMinimumLeaf procedure with branch_i, cost_i, the depth, the maximum cost, the failure probability, and the approximation margin to get a node N′ and to set a value best bound′ to equal the value COST(N′); and
returning, by the classical computer program, the node N when an absolute value of a difference between a minimum of the value incumbent and the value incumbent′ and a minimum of the value best bound and the value best bound′ is less than the approximation margin.

2. The method of claim 1, further comprising:
estimating, by the classical computer program, the depth and the maximum cost.

3. The method of claim 2, wherein the depth is estimated as a number of assets in a portfolio, and the maximum cost is estimated as the number of assets in the portfolio multiplied by a highest price of one of the assets in the portfolio.

4. The method of claim 1, wherein the step of executing, by the classical computer program, the subtree estimation procedure comprises:
executing, by the classical computer program, a cost subtree estimation procedure in response to the heuristic function being cost based; and
executing, by the classical computer program, a depth subtree estimation procedure in response to the heuristic function being depth based.

5. The method of claim 4, wherein the depth subtree estimation procedure returns the value for each Node N and keeps a child node present in the branch_m.

6. The method of claim 4, wherein the step of executing depth cost subtree estimation procedure in response to the heuristic function being depth based comprises:
instructing, by the classical computer program, the quantum computer to execute a quantum tree size procedure to get a size estimation.

7. The method of claim 4, wherein the cost subtree estimation procedure returns the branch_m comprising values in a tree V_1 as branch_1 and values in a tree V_2 as branch_2.

8. The method of claim 4, wherein the cost subtree estimation procedure iteratively estimates a size of a tree to reach a wanted cost until there are fewer that 2ⁱ⁺¹ nodes.

9. The method of claim 4, wherein the step of executing the cost subtree estimation procedure in response to the heuristic function being cost based comprises:
instructing, by the classical computer program, the quantum computer to execute a quantum tree size procedure to get a size estimation.

10. The method of claim 1, further comprising increasing the value of the counter i by 1, and repeating the steps of the classical computer program executing the subtree estimation procedure, determining the value branch_i and the value cost_i based on branch_m, assigning the value COST(N) to feasible nodes and a value +∞ to unfeasible nodes, instructing the quantum computer to execute the QuantumMinimumLeaf procedure with the value branch_i, the value COST(N), the depth, the maximum cost, the failure probability, and the approximation margin to get a node N and setting a value incumbent′ to equal to the value COST(N), instructing the quantum computer to execute the QuantumMinimumLeaf procedure with branch_i, cost_i, the depth, the maximum cost, the failure probability, and the approximation margin to get a node N′ and to set a value best bound′ to equal COST(N′), receiving the node N, and returning the node N when an absolute value of a difference between the minimum of the value incumbent and the value incumbent′ and the minimum of the value best bound and the value best bound′ is less than the approximation margin.

11. A system, comprising:
a classical computer comprising:
a memory storing a classical computer program; and
a computer processor; and
a quantum computer;
wherein:
the classical computer program receives a branch and bound problem comprising a root, a depth, a maximum cost, a failure probability, an approximation margin, and a heuristic function that is depth based or cost based;
the classical computer program sets an upper bound, a value best bound, a value incumbent, and a counter i;
the classical computer program executes a subtree estimation procedure with the root, a value 2ⁱ, a BRANCH function, a COST function, the depth, the failure probability, the approximation margin, and the heuristic function, wherein the subtree estimation procedure returns value branch_m that represents a tree of size m with minimal value for the heuristic function;
the classical computer program determines a value branch_i and a value cost_i based on branch_m;
the classical computer program sets a variable cost_feas to a value COST(N) for feasible nodes N, and to +∞ for unfeasible nodes;
the classical computer program instructs the quantum computer to execute a QuantumMinimumLeaf procedure with the value branch_i, the value COST(N), the depth, the maximum cost, the failure probability, and the approximation margin;
the quantum computer executes the QuantumMinimumLeaf procedure and returns a node N;
the classical computer program sets a value incumbent′ to equal to the value COST(N);
the classical computer program instructs the quantum computer to execute the QuantumMinimumLeaf procedure with branch_i, cost_i, the depth, the maximum cost, the failure probability, and the approximation margin;
the quantum computer executes the QuantumMinimumLeaf procedure and returns a node N′;
the classical computer program sets a value best bound′ to equal COST(N′); and
returning, by the classical computer program, the node N when an absolute value of a difference between a minimum of the value incumbent and the value incumbent′ and a minimum of the value best bound and the value best bound′ is less than the approximation margin.

12. The system of claim 11, wherein the classical computer program further estimates the depth and the maximum cost.

13. The system of claim 12, wherein the depth is estimated as a number of assets in a portfolio, and the maximum cost is estimated as the number of assets in the portfolio multiplied by a highest price of one of the assets in the portfolio.

14. The system of claim 11, wherein the classical computer program executes the subtree estimation procedure by:
executing, by the classical computer program, a cost subtree estimation procedure in response to the heuristic function being cost based; and
executing, by the classical computer program, a depth subtree estimation procedure in response to the heuristic function being depth based.

15. The system of claim 14, wherein the depth subtree estimation procedure returns the value for each Node N and keeps a child node present in the branch_m.

16. The system of claim 14, wherein the depth subtree estimation procedure comprises: instructing, by the classical computer program, the quantum computer to execute a quantum tree size procedure to get a size estimation.

17. The system of claim 14, wherein the cost subtree estimation procedure returns the branch_m comprising values in a tree V_1 as branch_1 and values in a tree V_2 as branch_2.

18. The system of claim 14, wherein the cost subtree estimation procedure iteratively estimates a size of a tree to reach a wanted cost until there are fewer that 2ⁱ⁺¹ nodes.

19. The system of claim 14, wherein the cost subtree estimation procedure comprises:
instructing, by the classical computer program, the quantum computer to execute a quantum tree size procedure to get a size estimation.

20. The system of claim 11, wherein the classical computer program increases the value of the counter i by 1, and repeats executing the subtree estimation procedure, determining the value branch_i and the value cost_i based on branch_m, assigning the value COST(N) to feasible nodes and a value +∞ to unfeasible nodes, instructing the quantum computer to execute the QuantumMinimumLeaf procedure with the value branch_i, the value COST(N), the depth, the maximum cost, the failure probability, and the approximation margin to get a node N and setting a value incumbent′ to equal to the value COST(N), instructing the quantum computer to execute the QuantumMinimumLeaf procedure with branch_i, cost_i, the depth, the maximum cost, the failure probability, and the approximation margin to get a node N′ and to set a value best bound′ to equal COST(N′), receiving the node N, and returning the node N when an absolute value of the difference between the minimum of the value incumbent and the value incumbent′ and the minimum of the value best bound and the value best bound′ is less than the approximation margin.
